(19) United States
(12) Patent Application Publication
(10) Pub. No.: US 2009/0057412 A1
(43) Pub. Date: Mar. 5, 2009

(54) Diagnosing malfunction of electro-optical reader

(76) Inventors: Kenneth S. Bhella, Stony Brook, NY (US); Edwin Booth, Brooklyn, NY (US); Viraj Jeevan Thameera Amarasekera, Upper Biyanwila (LK)

Correspondence Address: Kirschstein, Ottinger, Israel & Schiffmiller, P.C., 425 Fifth Avenue, New York, NY, 10016, US

(21) Appl. No.: 11/897,487

(22) Filed: Aug. 30, 2007

(51) Int. Cl. G06K 7/10; G06F 19/00

(52) U.S. Cl. 235/462.15; 235/472.01

(57) ABSTRACT

The operating parameters of data capture systems, such as electro-optical moving beam readers and imagers, are reported to a host in the event of a system malfunction by having a system operator scan a unique utility datum with the reader, or depress an actuator on the reader.

### BACKGROUND OF THE INVENTION

Various electro-optical readers have previously been developed for reading bar code symbols appearing on a label, or on a surface of a target. The bar code symbol itself is a coded pattern of indica. Generally, the readers electro-optically transform graphic indica of the symbols into electrical signals, which are decoded into alphanumeric characters. The resulting characters describe the target and/or some characteristic of the target with which the symbol is associated. Such characters typically comprise input data to a data processing system for applications in point-of-sale processing, inventory control, article tracking and the like.

Moving beam electro-optical readers have been disclosed, for example, in U.S. Pat. No. 4,251,798; No. 4,369,361; No. 4,387,297; No. 4,409,470; No. 4,760,248; and No. 4,896,026, and generally include a light source consisting of a gas laser or semiconductor laser for emitting a laser beam. The laser beam is optically modified, typically by a focusing optical assembly, to form a beam spot having a certain size at a predetermined target location. The laser beam is directed by a scanning component along an outgoing optical path toward a target symbol for reflection therefrom. In response to manual actuation of a physical trigger, the reader operates by repetitively scanning the laser beam in a scan pattern, for example, a line or a series of lines across the target symbol by movement of the scanning component, such as a scan mirror, disposed in the path of the laser beam. The scanning component may sweep the beam spot across the symbol, trace a scan line across and beyond the boundaries of the symbol, and/or scan a predetermined field of view.

Moving beam electro-optical readers also include a photodetector, which functions to detect laser light reflected or scattered from the symbol. In some systems, the photodetector is positioned in the reader in a return path so that it has a field of view, which extends at least across and slightly beyond the boundaries of the symbol. A portion of the laser beam reflected from the symbol is detected and converted into an analog electrical signal. A digitizer digitizes the analog signal. The digitized signal from the digitizer is then decoded by a microprocessor, based upon a specific symbology used for the symbol, into a binary data representation of the data encoded in the symbol. The binary data may then be converted into the alphanumeric characters represented by the symbol. The data may be decoded locally or sent to, and decoded in, a remote host for subsequent information retrieval.

Moving beam electro-optical readers have been used for reading one-dimensional symbols each having a row of bars and spaces spaced apart along one direction, and for processing two-dimensional symbols, such as Code 49, as well. Code 49 introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786.

Both one- and two-dimensional symbols can also be read by employing imaging readers. For example, a solid-state image sensor device may be employed which has a one- or two-dimensional array of cells or photosensors which correspond to image elements or pixels in a field of view of the device. In response to actuation of a physical trigger, the array captures light from the symbol. Such an image sensor device may include a one- or two-dimensional charge coupled device (CCD) or a complementary metal oxide semiconductor (CMOS) device and associated circuits for producing electronic signals corresponding to a one- or two-dimensional array of pixel information over the field of view. The electronic signals may be processed by a microprocessor either locally or sent to, and processed in, a remote host to read the symbol.

Depending upon the application, such moving beam and imaging readers, also described herein as data capture systems, can be configured in housings of various configurations, such as a gun-shaped housing typically held in the palm of an operator's hand, or a box-shaped housing that rests on a countertop to read symbols in a workstation mode, and is lifted off the countertop and aimed at the symbols to read them in a handheld mode. In parcel delivery and tracking applications, some of the components of each type of reader are mounted in one or more modules and supported on the body, neck, arm, wrist, and/or finger of the human operator, with a wired and/or wireless connection between the modules and with a base station. See, for example, U.S. Pat. No. 6,634,558 and No. 5,610,387. Such operator-supported readers are of especial benefit to parcel delivery personnel since it keeps the palms of both their hands free to pick up, hold and deliver parcels, as well as to receive delivery confirmations from recipients.

As advantageous as such moving beam scanners and imagers are in capturing data, such data capture systems are less than satisfactory when it comes to troubleshooting and correcting malfunctions in the field. When operating problems arise in such systems, much time and effort are required to report the problem, diagnose the problem, and service the problem. It is up to a human user to detect the problem and initiate the process of reporting the malfunction. Often, the user does not know how the system was set up or configured for the particular application, or what the preprogrammed operational settings are for normal operation.

As a diagnostic tool, it is known to load special utility software on the host, and to instruct the host to transmit a command to the data capture system to output its programmed settings. However, this software may not be available or loaded on the host when the malfunction occurs, with the result that the malfunction remains undiagnosed and uncorrected. This can lead to costly disruptions due to the system being out of service. Servicing generally requires the system to be returned to the manufacturer and perhaps disassembled for repair.

### SUMMARY OF THE INVENTION

One feature of this invention resides, briefly stated, in an arrangement for, and a method of, troubleshooting a data capture system having operational settings used to capture data. Preferably, the system may be a moving beam reader for electro-optically reading indica, such as bar code symbols, by scanning the symbols with a light beam, and by detecting light scattered from the symbols, or an imaging reader for electro-optically reading indica, again such as bar code symbols, by capturing light from the symbols with an array of image sensors.

In accordance with one feature of this invention, a system user is instructed to perform an action in the event of a system malfunction. This action may include instructing the user to operate the system to capture a unique utility datum on a target, for example, by electro-optically reading the utility datum. This action may alternatively include instructing the user to actuate a manual utility actuator on the system. Once this action is performed, a controller in the system, for example, a microprocessor, is operative for reporting the operational settings to a host operatively connected to, and remote from, the system. The host is operatively connected to the system by one of a wired and a wireless link.

Preferably, the target is a sheet of media, and the utility datum is a bar code symbol printed on the media sheet. The media sheet may be part of an operating manual for the system, or part of an email transmission sent to the user of the system, or part of a facsimile transmission sent to the user of the system. A help desk technician may initiate the email or facsimile transmission.

In a preferred embodiment, the controller is operative for reporting the operational settings as a text document to the host. The operational settings may include at least one of a communications protocol setting, a symbology setting, and a data formatting rule. The text document may be human- and/or machine-readable and preferably resides on the host where it can be accessed by the help desk technician for troubleshooting and diagnostic purposes.

Hence, when an operating problem arises in such systems, the system user initiates the process of reporting the malfunction to the help desk technician. It is the user, not the host, that performs the action that instructs the data capture system to output its programmed settings. The user need not, and typically does not, know how the system was set up or configured for the particular application, or what the preprogrammed settings are. It is sufficient for the technician to know that information. No special utility software needs to be loaded on the host. At most, a readily available text reader is provided on the host to read the programmed settings on the text document.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a diagrammatic view of an arrangement for troubleshooting a portable electro-optical moving beam reader operatively connected to a host in accordance with this invention;

FIG. 2 is a perspective view of an imaging reader for reading indica for use with the troubleshooting arrangement of this invention; and

FIG. 3 is a block circuit diagram of various components of the imaging reader of the type shown in FIG. 2.

### DETAILED DESCRIPTION OF THE PREFERRED EMBODIMENTS

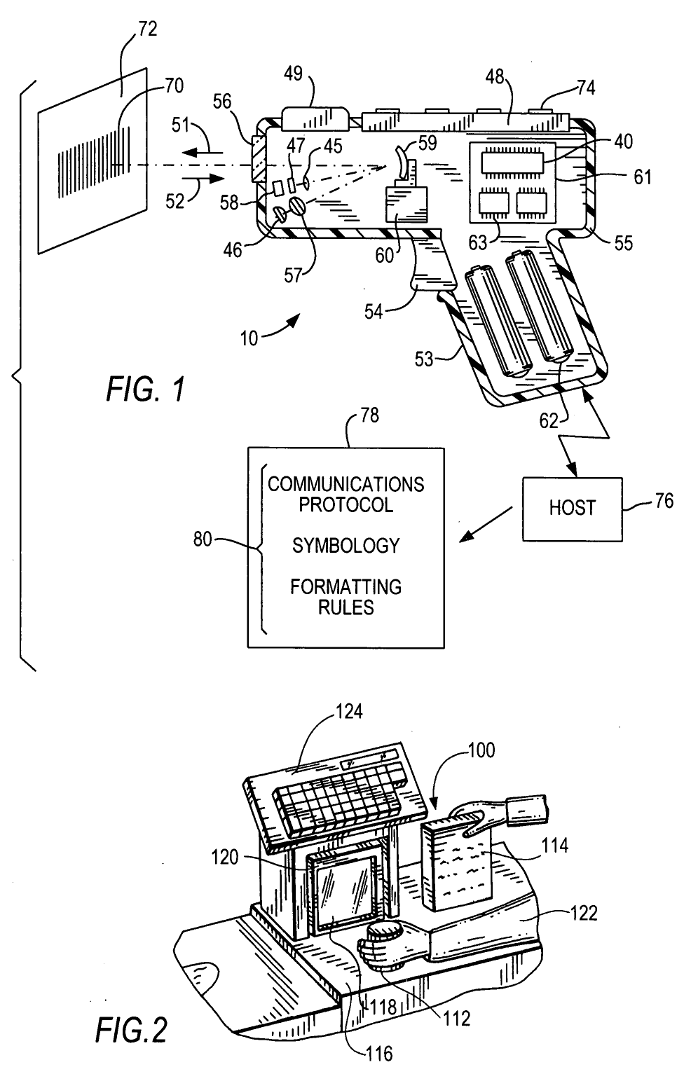

Referring now to the drawings, reference numeral 10 in FIG. 1 generally identifies a portable handheld moving beam reader for electro-optically reading indica such as bar code symbols. The reader 10 is preferably implemented as a gun-shaped device, having a pistol-grip handle 53. A lightweight plastic housing 55 contains a light source 46, a detector 58, optics 57, signal processing circuitry 63, a programmed controller or microprocessor 40, and a power source or battery pack 62. An exit window 56 at a front end of the housing 55 allows an outgoing light beam 51 to exit and incoming reflected return light 52 to enter. An operator aims the reader at a bar code symbol from a position in which the reader 10 is spaced from the symbol, i.e., not touching the symbol or moving across the symbol.

The optics 57 may include a suitable lens (or multiple lens system) to focus the light beam 51 into a scanning spot at an appropriate reference plane. The light source 46, such as a semiconductor laser diode, introduces a light beam into an optical axis of the lens 57, and other lenses or beam shaping structures as needed. The beam is reflected from an oscillating mirror 59 that is coupled to a scanning drive motor 60 energized when a trigger 54 is manually pulled. The oscillation of the mirror 59 causes the outgoing beam 51 to scan back and forth in a desired pattern, such as a scan line or a raster pattern of scan lines, across the symbol.

The return light 52 reflected or scattered back by the symbol passes back through the window 56 for transmission to the detector 58. In the exemplary reader shown in FIG. 1, the return light reflects off the mirror 59, passes through an optical bandpass filter 47 and impinges on the light sensitive detector 58. The filter 47 is designed to have a bandpass characteristic in order to pass the reflected (return) laser light and block the light coming from other optical sources. The detector 58 produces an analog signal proportional to the intensity of the reflected return light 52.

The signal processing circuitry includes a digitizer 63 mounted on a printed circuit board 61. The digitizer processes the analog signal from detector 58 to produce a pulse signal where the widths and spacings between the pulses correspond to the widths of the bars and the spacings between the bars of the symbol. The digitizer serves as an edge detector or wave shaper circuit, and a threshold value set by the digitizer determines what points of the analog signal represent bar edges. The pulse signal from the digitizer 63 is applied to a decoder, typically incorporated in the programmed microprocessor 40 which will also have associated program memory and random access data memory. The microprocessor decoder 40 first determines the pulse widths and spacings of the signal from the digitizer. The decoder then analyzes the widths and spacings to find and decode a legitimate bar code message. This includes analysis to recognize legitimate characters and sequences, as defined by the appropriate code standard. This may also include an initial recognition of the particular standard to which the scanned symbol conforms. This recognition of the standard is typically referred to as autodiscrimination. A keyboard 48 and a display 49 may advantageously be provided on a top wall of the housing for ready access thereto.

To scan the symbol, the operator aims the bar code reader 10 and operates the movable trigger switch 54 to activate the light source 46, the scanning motor 60 and the signal processing circuitry. If the scanning light beam 51 is visible, the operator can see a scan pattern on the surface on which the symbol appears and adjust aiming of the reader 10 accordingly. If the light beam 51 produced by the source 46 is marginally visible, an aiming light may be included. The aiming light, if needed, produces a visible light spot that may be fixed, or scanned just like the laser beam 51. The operator employs this visible light to aim the reader at the symbol before pulling the trigger.

In accordance with one feature of this invention, the system operator is instructed to perform an action in the event of a malfunction of the reader 10. This action may include instructing the operator to operate the reader 10 to capture a unique utility datum 70 on a target 72, for example, by electro-optically reading the utility datum 70. This action may alternatively include instructing the operator to actuate a manual utility actuator, such as manually depressing a key or button 74, on the reader. Once this action is performed, the controller 40 in the reader is operative for reporting preprogrammed operational parameters or settings 80, as described below, to a host 76 operatively connected to, and remote from, the reader 10. The host 76 is operatively connected to the reader 10 by one of a wired and a wireless link.

Preferably, the target 72 is a sheet of media, and the utility datum 70 is a bar code symbol printed on the media sheet 72. This symbol 70 is unique and different from all other symbols to be read. Indeed, the controller is programmed to report the operational settings 80 when this unique symbol 70 is read. The media sheet 72 may be part of an operating manual for the reader, or part of an email transmission sent to the operator of the reader, or part of a facsimile transmission sent to the operator of the reader. A help desk technician may initiate the email or facsimile transmission.

In a preferred embodiment, the controller 40 is operative for reporting the operational settings 80 as a text document 78 to the host 76. The operational settings 80 may include at least one of a communications protocol setting, e.g., USB, RS-232, RS-485, or other communications protocol; a symbology setting, e.g., one- and/or two-dimensional symbologies such as UPC, Code-49, PDF-417, or like symbology; and a data formatting rule, e.g., should the key “ENTER” be depressed after each data capture. Other operational settings 80, such as beeper volume, are also contemplated. The text document 78 may be human- and/or machine-readable and preferably resides on the host 76 where it can be accessed by the help desk technician for troubleshooting and diagnostic purposes.

Hence, when an operating problem arises in such readers, the system operator initiates the process of reporting the malfunction to the help desk technician. It is the operator, not the host 76, that performs the action that instructs the reader to output its programmed settings 80. The operator need not, and typically does not, know how the reader was set up or configured for the particular application, or what the preprogrammed settings 80 are. It is sufficient for the technician to know that information. No special utility software needs to be loaded on the host 76. At most, a readily available text reader, such as Microsoft NotePad (trademark) is provided on the host 76 to read the programmed settings 80 on the text document 78.

As an example of another type of reader or data capture system whose malfunction can be diagnosed in accordance with this invention, reference numeral 100 in FIG. 2 generally identifies a point-of-sale workstation having an electro-optical imaging reader in a workstation mode for processing transactions and mounted on a checkout counter at a retail site at which products, such as a can 112 or a box 114, each bearing a target symbol, are processed for purchase. The counter includes a countertop 116 on which a box-shaped vertical slot reader 120 having a generally vertical window 118 rests. A checkout clerk or operator 122 is located at one side of the countertop, and the reader 120 is located at the opposite side. A cash/credit register 124 is located within easy reach of the operator. In the workstation mode, the operator presents the symbols on the products to the window 118. The reader 120 is portable and lightweight and may be picked up from the countertop 116 by the operator 122 in a handheld mode, and the window 118 may be aimed at a symbol preferably on a product too heavy, or too large, or too bulky to be easily positioned on the countertop in front of the window of the reader in the workstation mode.

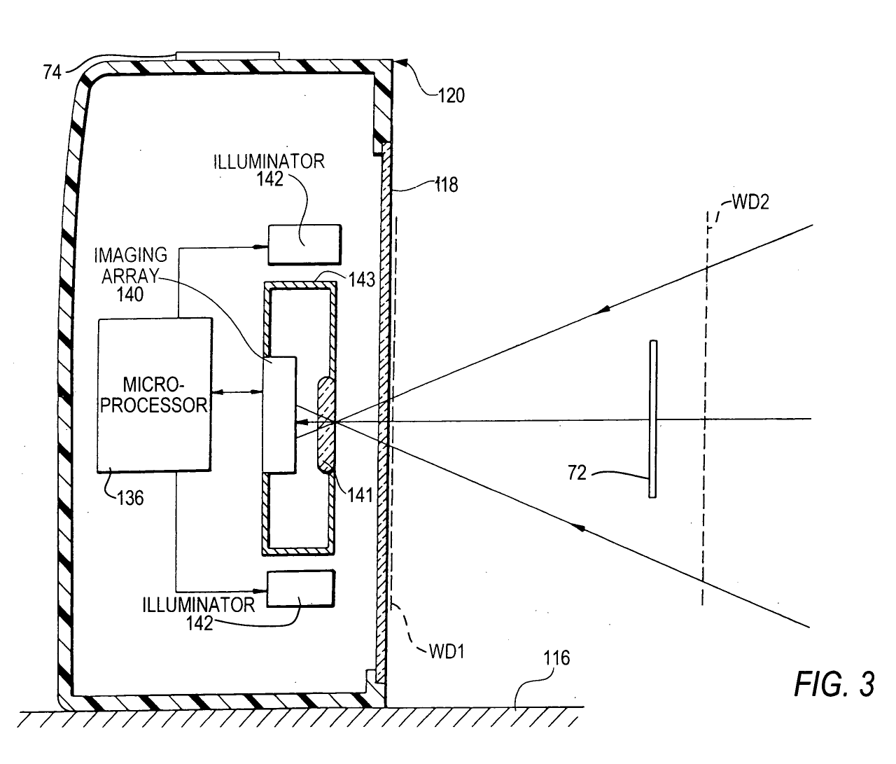

As shown in FIG. 3, the imaging reader 120 includes an imager 140 and a focusing lens 141 that are mounted in an enclosure 143. The imager 140 is a solid-state device, for example, a CCD or a CMOS imager and has a linear or area array of addressable image sensors operative for capturing light through the window 118 from a target symbol, for example, a one- or two-dimensional symbol, over a field of view and located in a working range of distances between a close-in working distance (WD1) and a far-out working distance (WD2). In a preferred embodiment, WD1 is about two inches from the imager array 140 and generally coincides with the window 118, and WD2 is about eight inches from the window 118. An illuminator 142 is also mounted in the reader and preferably includes a plurality of light sources, e.g., light emitting diodes (LEDs) 142, arranged around the imager 140 to uniformly illuminate the target symbol.

As also shown in FIG. 3, the imager 140 and the illuminator 142 are operatively connected to a controller or microprocessor 136 operative for controlling the operation of these components. Preferably, the microprocessor is the same as the one used for decoding light scattered from the indica and for processing the captured target symbol images.

In operation, the microprocessor 136 sends a command signal to the illuminator 142 to pulse the LEDs for a short time period of 500 microseconds or less, and energizes the imager 140 to collect light from a target symbol substantially only during said time period. A typical array needs about 33 milliseconds to read the entire target image and operates at a frame rate of about 30 frames per second. The array may have on the order of one million addressable image sensors.

Hence, in accordance with this invention, the controller 40 of FIG. 1, or the controller 136 of FIG. 3, is operative for sensing when the operator has performed the above-described action, e.g., reading the utility datum 70, or depressing the actuator 74, in the event of a reader malfunction, and for automatically reporting the operational settings 80 of each reader 10, 120 to the host 76 for diagnosis by a technician. The text document can be read directly by the technician, or interpreted by software. The technician can copy the operational settings 80 onto another reader for diagnostic purposes.

It will be understood that each of the elements described above, or two or more together, also may find a useful application in other types of constructions differing from the types described above.

While the invention has been illustrated and described as embodied in diagnosing malfunctions in an electro-optical reader and method, it is not intended to be limited to the details shown, since various modifications and structural changes may be made without departing in any way from the spirit of the present invention. For example, a design engineer may use this invention not for troubleshooting, but for experimenting with the operational settings for design purposes.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An arrangement for use in correcting malfunction of a data capture system having operational settings used to capture data, comprising:
a host operatively connected to, and remote from, the system;
a target bearing a utility datum; and
a controller in the system, for reporting the operational settings to the host when the utility datum is captured by the system.

2. The arrangement of claim 1, wherein the system is an electro-optical reader for reading bar code symbols with a laser beam scanned across the indica, and wherein the utility datum is a bar code symbol.

3. The arrangement of claim 1, wherein the system is an electro-optical reader for reading bar code symbols by capturing light from the indica, and wherein the utility datum is a bar code symbol.

4. The arrangement of claim 1, wherein the system is an electro-optical reader for reading bar code symbols, wherein the target is a sheet of media, and wherein the utility datum is a bar code symbol printed on the media sheet.

5. The arrangement of claim 4, wherein the media sheet is part of an operating manual for the system.

6. The arrangement of claim 4, wherein the media sheet is part of an email transmission sent to a user of the system.

7. The arrangement of claim 4, wherein the media sheet is part of a facsimile transmission sent to a user of the system.

8. The arrangement of claim 1, wherein the controller is operative for reporting the operational settings as a text document to the host.

9. The arrangement of claim 8, wherein the operational settings include at least one of a communications protocol setting, a symbology setting, and a data formatting rule.

10. The arrangement of claim 1, wherein the host is operatively connected to the system by one of a wired and a wireless link.

11. An arrangement for use in correcting malfunction of a data capture system having operational settings used to capture data, comprising:
a host operatively connected to, and remote from, the system;
a manually actuatable actuator on the system; and
a controller in the system, for reporting the operational settings to the host when the actuator is actuated by a system user.

12. A method for use in correcting malfunction of a data capture system having operational settings used to capture data, comprising the steps of:
operatively connecting a host to, and remote from, the system;
providing a utility datum on a target; and
reporting the operational settings from a controller in the system to the host when the utility datum is captured by the system.

13. The method of claim 12, wherein the system captures data by scanning a laser beam across bar code symbols to be electro-optically read, and forming the utility datum as a bar code symbol.

14. The method of claim 12, wherein the system captures data by capturing light from bar code symbols to be electro-optically read, and forming the utility datum as a bar code symbol.

15. The method of claim 12, wherein the system captures data by reading bar code symbols, constituting the target as a sheet of media, and printing the utility datum as a bar code symbol on the media sheet.

16. The method of claim 15, and constituting the media sheet as part of an operating manual for the system.

17. The method of claim 15, and constituting the media sheet as part of an email transmission sent to a user of the system.

18. The method of claim 15, and constituting the media sheet as part of a facsimile transmission sent to a user of the system.

19. The method of claim 12, and reporting the operational settings as a text document to the host.

20. The method of claim 19, wherein the operational settings include at least one of a communications protocol setting, a symbology setting, and a data formatting rule.

21. The method of claim 12, and operatively connecting the host to the system by one of a wired and a wireless link.

22. A method for use in correcting malfunction of a data capture system having operational settings used to capture data, comprising the steps of:
operatively connecting a host to, and remote from, the system;
providing a manual actuator on the system; and
reporting the operational settings from a controller in the system to the host when the actuator is actuated by a system user.

23. A method of troubleshooting a data capture system having operational settings used to capture data, comprising the steps of:
instructing a system user to perform an action in the event of a system malfunction; and
reporting the operational settings to the host when the action is performed by the system user.
